(19) United States
(12) Patent Application Publication
(10) Pub. No.: US 2012/0128413 A1
(43) Pub. Date: May 24, 2012

(54) VEHICLE SECURING STRUCTURE

(75) Inventor: Sachiko Suwazono, Kofu-shi (JP)

(73) Assignee: MEIDENSHA CORPORATION, Tokyo (JP)

(21) Appl. No.: 13/388,489

(22) PCT Filed: Jul. 23, 2010
(86) PCT No.: PCT/JP2010/062436

§ 371 Date: Feb. 2, 2012

(30) Foreign Application Priority Data
Aug. 4, 2009 (JP) 2009-181245

(51) Int. Cl. F16B 17/00

(52) U.S. Cl. 403/345

(57) ABSTRACT

Conventionally, the linking adapter in a vehicle securing device (1) is shaped as a square column, but this leads to problems in that the adapter insertion part is shaped as a square hole and therefore when a test vehicle tilts to the left or right during acceleration or braking in a vehicle test, the corner parts of the square-column-shaped adapter press against the inner surface of the adapter insertion part so that the test vehicle is immobilized and freed, and it is difficult to reproduce the tyre force and workload in the vehicle test. A test vehicle securing structure with which a test vehicle is secured by inserting a linking adapter (9A) in a vehicle securing device (1A) into an adapter insertion part provided in a test vehicle (101), wherein the adapter insertion part comprises a spherical bearing (102A). The adapter (9A) is formed with a cylindrical shape, while a bearing hole (14) in the spherical bearing (102A) is formed with a circular shape.

### TECHNICAL FIELD

The present invention relates to a vehicle securing structure comprising: an adapter insertion part provided in a vehicle such as a test vehicle; and a linking adapter in a vehicle securing device, wherein insertion of the linking adapter into the adapter insertion part secures the vehicle.

### BACKGROUND ART

There is developed one such vehicle securing device as shown in FIG. 6. The vehicle securing device 1 includes a device base part 3, an arm support part 4, and an arm part 5, wherein the device base part 3 is provided in a test room and configured to slide along a rail 2 in a direction of arrow A (in a longitudinal direction of a test vehicle 101), wherein the arm support part 4 is arranged on an upper surface side of the device base part 3, and wherein the arm part 5 is cantilevered by the arm support part 4.

The arm support part 4 is supported for sliding along a rail 6 in a direction of arrow B (in a lateral direction of the test vehicle 101), wherein the rail 6 is provided on the upper surface of the device base part 3. The arm part 5 is configured to slide along a rail 7 in a direction of arrow C (in a vertical direction of the test vehicle 101), wherein the rail 7 is provided on a side surface of the device base part 3. 8 denotes a roller of a chassis dynamometer.

As shown in FIG. 7, an adapter (attachment) 9 for vehicle linkage is attached detachably to a distal end portion of the arm part 5. Insertion of the adapter 9 into an adapter insertion part 102 secures the test vehicle 101, wherein the adapter insertion part 102 is provided on a bottom surface of the test vehicle 101. The adapter insertion part 102 is implemented by a torque box hole provided on the bottom surface of the test vehicle 101. If no torque box hole exists, the adapter insertion part 102 is presented by providing a jig (not shown) with the adapter insertion part 102, and mounting the jig to a jig mount part on the bottom surface of the test vehicle 101 such as a reinforcing beam or side sill.

As shown in FIG. 8, the adapter 9 has a rectangular prism form, whereas the adapter insertion part 102 has a rectangular hole form. The adapter 9 is inserted into the adapter insertion part 102 with the four surfaces of the adapter 9 conformed to the four surfaces of the adapter insertion part 102, thereby position and secure the test vehicle 101. Such vehicle securing devices are known in patent documents 1, 2 and 3.

### PRIOR ART DOCUMENT(S)

### Patent Document(s)

Patent document 1: JP 3175587 B2 (paragraphs 0004-0006, etc.)

Patent document 2: JP 3109396 B2 (paragraphs 0029-0034, etc.)

Patent document 3: JP 3617231 B2

### SUMMARY OF THE INVENTION

### Problem(s) to be Solved by the Invention

As described above, conventionally, the linking adapter 9 in the vehicle securing device 1 has a rectangular prism form, whereas the adapter insertion part 102 has a rectangular hole form. Accordingly, when the test vehicle 101 gets inclined left and right at acceleration or deceleration during vehicle testing, corner portions 9a of the adapter 9 in the rectangular prism form are brought into pressing contact with an inside surface of the adapter insertion part 102 as shown in FIG. 9. This causes a phenomenon that the test vehicle 101 gets restrained and released repeatedly, and thereby adversely affects repeatability of tire force distribution and workload during vehicle testing.

The present invention is made to solve the conventional problem described above.

### Means for Solving the Problem(s)

According to the invention of Claim 1, a vehicle securing structure comprising: an adapter insertion part provided in a vehicle; and a linking adapter in a vehicle securing device, wherein insertion of the linking adapter into the adapter insertion part secures the vehicle; wherein the adapter insertion part comprises a spherical bearing.

According to the invention of Claim 2, in the vehicle securing structure according to Claim 1, the spherical bearing has a central bearing hole, wherein the bearing hole has a circular form; and the linking adapter has a circular cylindrical form.

According to the invention of Claim 3, in the vehicle securing structure according to Claim 1 or 2, the spherical bearing is set in a spherical bearing setting jig; and the spherical bearing setting jig is attached to a bottom surface of the vehicle.

According to the invention of Claim 4, in the vehicle securing structure according to Claim 3, the spherical bearing setting jig comprises: a spherical-bearing-supporting member to which the spherical bearing is attached; and mounting members provided at corresponding different longitudinal end portions of the spherical-bearing-supporting member, wherein the mounting members attach the spherical-bearing-supporting member to the bottom surface of the vehicle.

### Effect(s) of the Invention

The feature of the vehicle securing structure according to Claim 1 that the adapter insertion part comprises a spherical bearing, wherein the linking adapter of the vehicle securing device is inserted into the adapter insertion part, serves to obtain repeatability of behavior because the spherical bearing absorbs inclination, etc., of the vehicle.

The feature of the vehicle securing structure according to Claim 2 that the spherical bearing has a central bearing hole, wherein the bearing hole has a circular form; and the linking adapter has a circular cylindrical form, allows to easily insert the adapter into the adapter insertion part regardless of inclination, etc., of the vehicle.

The feature of the vehicle securing structure according to Claim 3 that the spherical bearing is set in a spherical bearing setting jig; and the spherical bearing setting jig is attached to a bottom surface of the vehicle, allows to secure the vehicle even if the vehicle is provided with no torque box hole on the bottom surface of the vehicle.

The feature of the vehicle securing structure according to Claim 4 that the spherical bearing setting jig comprises: a spherical-bearing-supporting member to which the spherical bearing is attached; and mounting members provided at corresponding different longitudinal end portions of the spherical-bearing-supporting member, wherein the mounting members attach the spherical-bearing-supporting member to the bottom surface of the vehicle, wherein the jig mount part such as a reinforcing beam or side sill on the bottom surface of the test vehicle is sandwiched, allows to attach the spherical bearing setting jig to the bottom surface of the vehicle.

### BRIEF DESCRIPTION OF THE DRAWINGS

FIG. 1 is a diagram illustrating a connection structure of a vehicle securing device according to the present invention;

FIG. 2 is a diagram illustrating a condition that a spherical bearing setting jig is attached to a test vehicle;

FIG. 3 (A) is a plan view of the spherical bearing setting jig, FIG. 3 (B) is a front view of the spherical bearing setting jig, and FIG. 3 (C) is a side view of the spherical bearing setting jig;

FIGS. 4 (A) and (B) show a modified example of the spherical bearing setting jig, wherein FIG. 4 (A) is a front view, and FIG. 4 (B) is a side view;

FIGS. 5 (A) and (B) are diagrams illustrating an assembling process for the spherical bearing setting jig of the modified example;

FIG. 6 is a perspective view showing a conventional example of vehicle securing device;

FIG. 7 is a sectional view showing a relationship between a conventional adapter and a conventional adapter insertion part;

FIG. 8 is a perspective view showing shapes of the conventional adapter and conventional adapter insertion part; and

FIG. 9 is a diagram illustrating a problem with the conventional example.

### BEST MODE FOR CARRYING OUT THE INVENTION

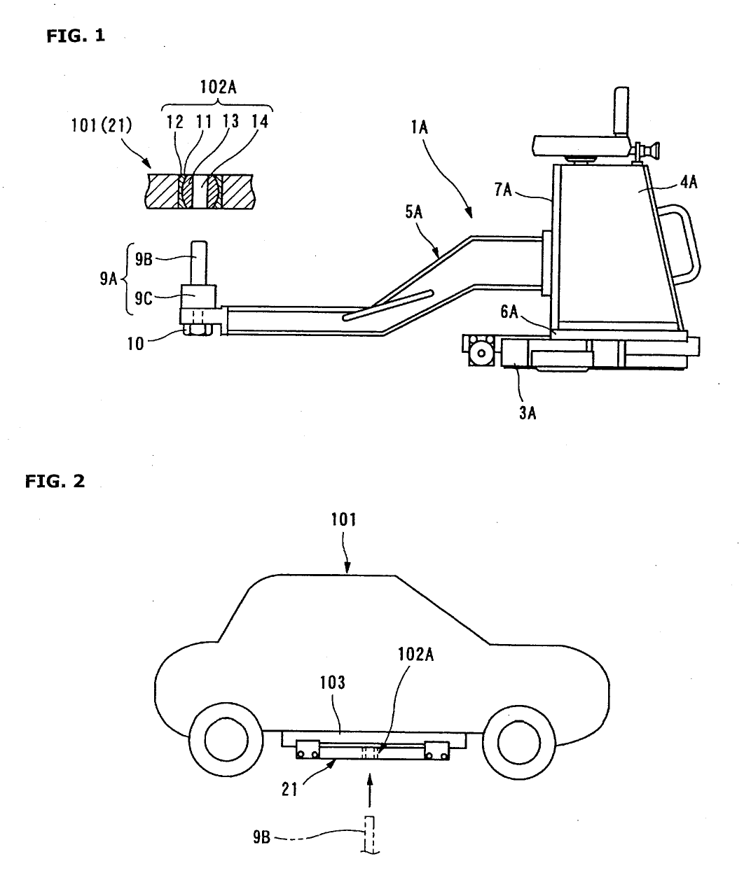

FIGS. 1 to 3 show a vehicle securing structure according to the present invention. As shown in FIG. 1, insertion of a linking adapter 9A of a vehicle securing device 1A into an adapter insertion part 102A provided in a test vehicle 101 secures the test vehicle 101.

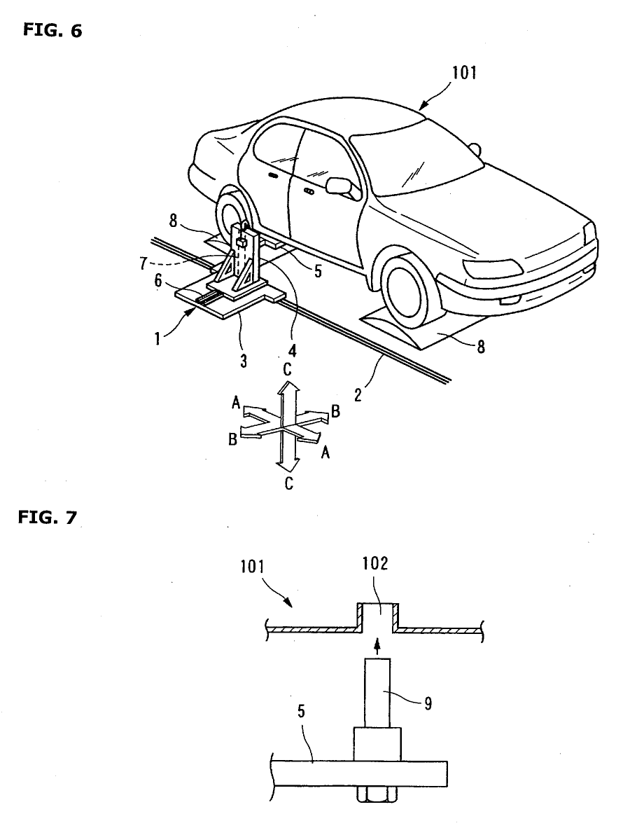

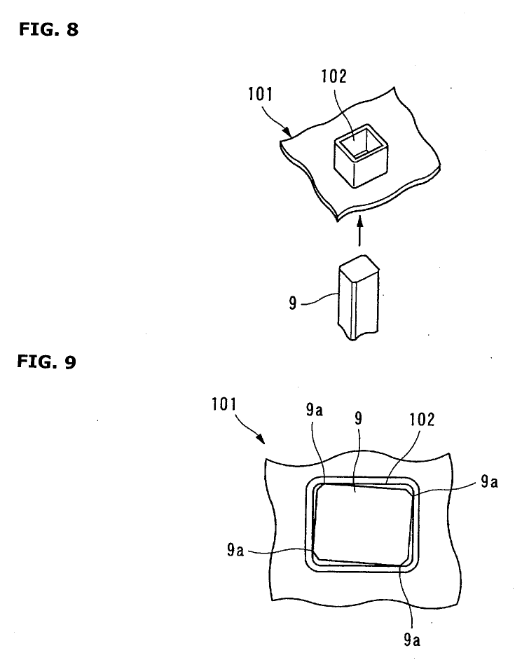

The vehicle securing device 1A has a different outside shape from that of the vehicle securing device 1, which is described with reference to FIG. 6, but has a similar configuration as the vehicle securing device 1. The vehicle securing device 1A includes a device base part 3A, an arm support part 4A, and an arm part 5A, wherein the device base part 3A is provided in a test room and configured to slide along a rail 2A (not shown) in a longitudinal direction of the test vehicle 101, wherein the arm support part 4A is arranged on an upper surface side of the device base part 3A, and wherein the arm part 5A is cantilevered by the arm support part 4A.

The arm support part 4A is supported for sliding along a rail 6A in a lateral direction of the test vehicle 101, wherein the rail 6A is provided on the upper surface of the device base part 3A. The arm part 5A is configured to slide along a rail 7A in a vertical direction of the test vehicle 101, wherein the rail 7A is provided on a side surface of the arm support part 4A.

The adapter 9A includes a small diameter portion 9B and a large diameter portion 9C, and is attached detachably to an upper surface of the arm part 5A by a bolt 10, wherein the small diameter portion 9B has a circular cylinder form and is inserted into the adapter insertion part 102A described below, and wherein the large diameter portion 9C is continuous with a lower end of the small diameter portion 9B.

The adapter insertion part 102A comprises a spherical bearing. In the following, the adapter insertion part 102A is referred to as spherical bearing.

The spherical bearing 102A includes an outer ring 12 and an inner ring 13 which are in contact with each other at a sliding surface 11 having a spherical form.

The inner ring 13 is formed with a bearing hole 14 in its central portion, wherein the small diameter portion 9B of the adapter 9A in the circular cylinder form is inserted into the bearing hole 14 in the circular form.

As shown in FIG. 2, the spherical bearing 102A is provided in a spherical bearing setting jig 21 that is mounted to a jig mount part 103 such as a reinforcing beam or side sill on the bottom surface of the test vehicle 101.

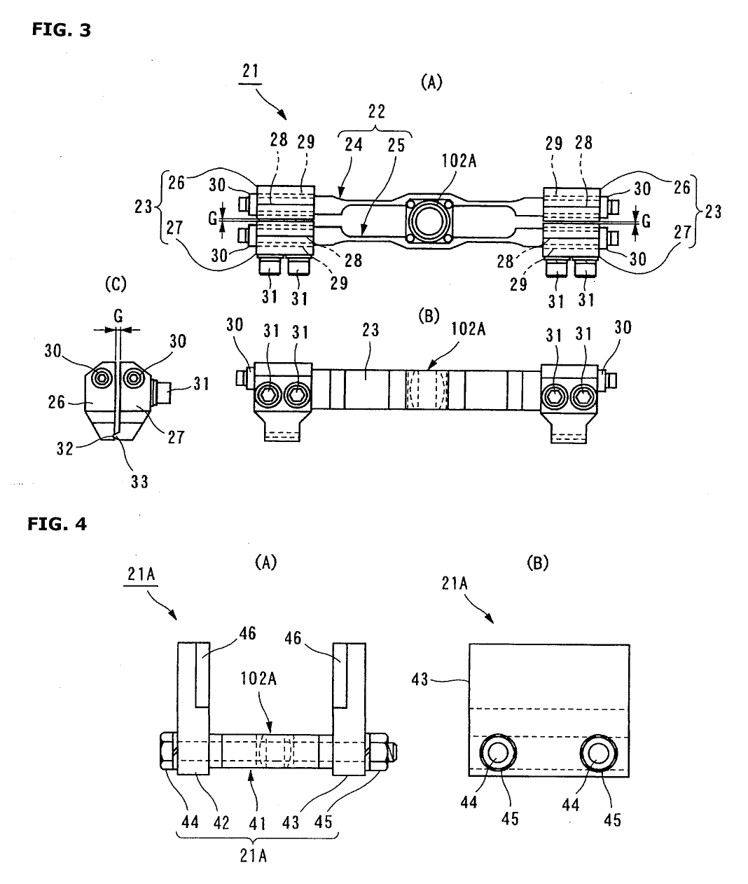

As shown in FIGS. 3 (A) and (B), the spherical bearing setting jig 21 includes a spherical bearing mount member 22, and mounting members 23, 23, wherein the spherical bearing 102A is attached to the spherical bearing mount member 22, and wherein the mounting members 23, 23 are provided at corresponding different longitudinal end portions of the spherical bearing mount member 22, and mount the spherical bearing mount member 22 to the jig mount part 103 such as a reinforcing beam or side sill on the bottom surface of the test vehicle 101 (see FIG. 2).

The spherical bearing mount member 22 supports the spherical bearing 102A between a pair of arms 24, 25. Each mounting member 23 is composed of a pair of sandwiching members 26, 27 which sandwich the jig mount part 103 such as a reinforcing beam or side sill on the bottom surface of the test vehicle 101. The sandwiching member 26 is attached to a distal end portion of the arm 24 by inserting a sandwiching member mount shaft 28 provided at the end portion of the arm 24 into a sandwiching member mount shaft insertion hole 29 provided in the sandwiching member 26, and attaching a release-preventing member 30 such as a nut to an end portion of the sandwiching member mount shaft 28. The other sandwiching member 27 is attached to a distal end portion of the arm 25 by inserting a sandwiching member mount shaft 28 provided at the end portion of the arm 25 into a sandwiching member mount shaft insertion hole 29 provided in the sandwiching member 27, and attaching a release-preventing member 30 such as a nut to an end portion of the sandwiching member mount shaft 28.

At least one of the sandwiching member mount shaft 28 provided at the end portion of the arm 24 and the sandwiching member mount shaft 28 provided at the end portion of the arm 25 is inserted in the sandwiching member mount shaft insertion hole 29 with a predetermined clearance for play, namely, is loosely fitted in the sandwiching member mount shaft insertion hole 29, so that a clearance G between the sandwiching members 26, 27 is adjustable within the clearance for play.

The sandwiching members 26, 27 are provided with a plurality of tightening bolts 31, which are tightened to cause the sandwiching members 26, 27 to approach each other and thereby reduce the clearance G.

As shown in FIG. 3 (C), the sandwiching members 26, 27 are provided with a recess 32 and a projection 33, respectively, at surfaces of lower end portions of the sandwiching members 26, 27 facing each other, wherein the projection 33 engages with the recess 32. The recess 32 and projection 33 serve as a fulcrum when the sandwiching members 26, 27 are being tightened with the plurality of tightening bolts 31.

Next, the following describes a method of assembling the spherical bearing setting jig 21 to the test vehicle. First, the jig mount part 103 such as a reinforcing beam or side sill on the bottom surface of the test vehicle 101 is inserted into the clearance G between the sandwiching members 26, 27. Then, the tightening bolts 31 are rotated in the tightening direction. The rotation of the tightening bolts 31 causes the sandwiching members 26, 27 to approach each other with the recess 32 and projection 33 as a fulcrum, to reduce the clearance G, and thereby sandwich the jig mount part 103, such as a reinforcing beam or side sill on the bottom surface of the test vehicle 101, by upper end portions of the surfaces of the sandwiching members 26, 27 facing each other, and thereby attach same to the bottom surface of the test vehicle 101.

Then, as shown in FIG. 1, the upper end portion of the adapter 9A of the vehicle securing device 101 is inserted into the bearing hole 14 of the spherical bearing 102A of the spherical bearing setting jig 21, thereby positioning and securing the test vehicle 101.

FIG. 4 shows a modified example of spherical bearing setting jig. The spherical bearing setting jig 21A of this modified example is composed of a spherical bearing mount member 41, a pair of mounting members 42, 43, and a plurality of bolts 44 and nuts 45, wherein the spherical bearing 102A is attached to a central portion of the spherical bearing mount member 41, wherein the mounting members 42, 43 are arranged at corresponding different end portions of the spherical bearing mount member 41, sandwiching the spherical bearing mount member 41, and wherein the bolts 44 and nuts 45 attach the mounting members 42, 43 to the end portions of the spherical bearing mount member 41, and bring the mounting members 42, 43 into pressing contact with the jig mount part 103 such as a reinforcing beam or side sill on the bottom surface of the test vehicle 101. 46 denotes a nonslip member such as made of rubber, which is provided on surfaces of the mounting members 42, 43 facing each other.

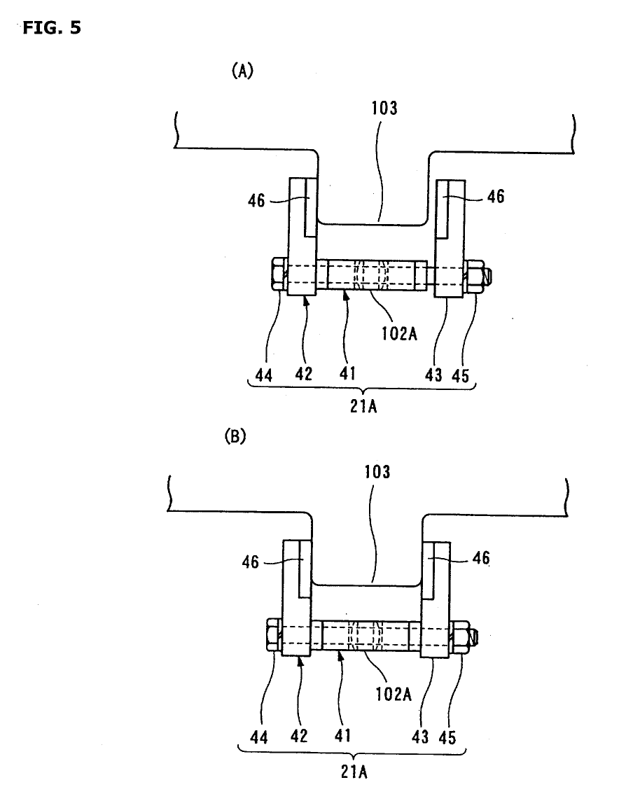

The spherical bearing setting jig 21A of the modified example is constructed as described above. First, as shown in FIG. 5 (A), the nut 45 is released to increase the clearance between the pair of mounting members 42, 43, and the jig mount part 103 such as a reinforcing beam or side sill of the test vehicle 101 is inserted into between the mounting members 42, 43. Then, as shown in FIG. 5 (B), the nut 45 is tightened so that the mounting members 42, 43 sandwich the jig mount part 103 such as a reinforcing beam or side sill on the bottom surface of the test vehicle 101, and thereby attach the spherical bearing setting jig 21A to the jig mount part 103. Then, the upper end portion of the adapter 9A of the vehicle securing device 101 is inserted into the bearing hole of the spherical bearing 102A of the spherical bearing setting jig 21, thereby positioning and securing the test vehicle 101.

### INDUSTRIAL APPLICABILITY

The embodiments described above are shown in the cases where the test vehicle is secured on the chassis dynamometer, but may be also applied to other cases of securing a test vehicle.

### DESCRIPTION OF REFERENCE SINGS

1 . . . Vehicle securing device

9, 9A . . . Linking adapter

11 . . . Sliding surface

12 . . . Outer ring

13 . . . Inner ring

14 . . . Bearing hole

21, 21A . . . Spherical bearing setting jig

22 . . . Spherical bearing mount member

23 . . . Mounting member

24, 25 . . . Arm

26, 27 . . . Sandwiching member

28 . . . Sandwiching member mount shaft

29 . . . Sandwiching member mount shaft insertion hole

30 . . . Release-preventing member

31 . . . Tightening bolt

32 . . . Recess

33 . . . Projection

101 . . . Test vehicle

102, 102A . . . Adapter insertion part (Spherical bearing)

103 . . . Jig mount part, such as a side sill or beam

1. A vehicle securing structure comprising:
an adapter insertion part provided in a vehicle; and
a linking adapter in a vehicle securing device, wherein insertion of the linking adapter into the adapter insertion part secures the vehicle;
characterized in that the adapter insertion part comprises a spherical bearing.

2. The vehicle securing structure as claimed in claim 1, characterized in that:
the spherical bearing has a central bearing hole, wherein the bearing hole has a circular form; and
the linking adapter has a circular cylindrical form.

3. The vehicle securing structure as claimed in claim 1, characterized in that:
the spherical bearing is set in a spherical bearing setting jig; and
the spherical bearing setting jig is attached to a bottom surface of the vehicle.

4. The vehicle securing structure as claimed in claim 3, characterized in that:
the spherical bearing setting jig comprises:
a spherical-bearing-supporting member to which the spherical bearing is attached; and
mounting members provided at corresponding different longitudinal end portions of the spherical-bearing-supporting member, wherein the mounting members attach the spherical-bearing-supporting member to the bottom surface of the vehicle.

5. The vehicle securing structure as claimed in claim 2, characterized in that:
the spherical bearing is set in a spherical bearing setting jig; and
the spherical bearing setting jig is attached to a bottom surface of the vehicle.

6. The vehicle securing structure as claimed in claim 5, characterized in that:
the spherical bearing setting jig comprises:
a spherical-bearing-supporting member to which the spherical bearing is attached; and
mounting members provided at corresponding different longitudinal end portions of the spherical-bearing-supporting member, wherein the mounting members attach the spherical-bearing-supporting member to the bottom surface of the vehicle.
